(19) United States
(12) Patent Application Publication
(10) Pub. No.: US 2025/0372294 A1
(43) Pub. Date: Dec. 4, 2025

(54) REACTOR, SEGMENT, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masato NADA, Mie (JP); Kazushi KUSAWAKE, Mie (JP); Shinichiro YAMAMOTO, Mie (JP)

(21) Appl. No.: 18/875,169

(22) PCT Filed: Jun. 5, 2023
(86) PCT No.: PCT/JP2023/020877

§ 371 Date: Dec. 16, 2024

(30) Foreign Application Priority Data
Jun. 22, 2022 (JP) 2022-100680

(51) Int. Cl. H01F 27/24; H01F 27/28

(52) U.S. Cl. CPC H01F 27/24; H01F 27/28

(57) ABSTRACT

A reactor includes a coil including a winding portion and a magnetic core. The magnetic core includes a plurality of segments including a first core piece. The first core piece is made of a composite material containing a resin and a soft magnetic powder dispersed in the resin, and includes a first part extending in a direction orthogonal to an axial direction of the winding portion and arranged at a position facing an end surface of the winding portion and a second part extending in the axial direction from the first part. The first and second parts are continuously formed without any joint. A first relative magnetic permeability of the first part for a magnetic flux along an extension direction of the first part and a second relative magnetic permeability of the second part for a magnetic flux along an extension direction of the second part are different.

### TECHNICAL FIELD

The present disclosure relates to a reactor, a segment, a converter and a power conversion device.

This application claims a priority based on Japanese Patent Application No. 2022-100680 filed on Jun. 22, 2022, all the contents of which are hereby incorporated by reference.

### BACKGROUND

Constituent components of a converter provided in a hybrid vehicle and the like include a reactor. For example, reactors described in Patent Document 1 and Patent Document 2 are provided with a coil and a magnetic core. The coil includes winding portion(s) formed by winding a winding wire. One winding portion may be provided or a plurality of winding portions may be provided.

The magnetic core is configured by combining a plurality of segments. The segment is, for example, a powder compact formed by compression-forming a soft magnetic powder or a compact of a composite material, in which a soft magnetic powder is dispersed in a resin. The compact of the composite material easily achieves desired magnetic properties by changing a mixing ratio of the soft magnetic powder and the resin. The compact of the composite material can reduce an iron loss in the use of the reactor at high frequencies.

### PRIOR ART DOCUMENT

### Patent Document

Patent Document 1: JP 2017-135334 A

Patent Document 2: JP 2016-201509 A

### SUMMARY OF THE INVENTION

A reactor of the present disclosure is provided with a coil including a winding portion and a magnetic core, the magnetic core including a plurality of segments including a first core piece, the first core piece being made of a composite material containing a resin and a soft magnetic powder dispersed in the resin, the first core piece including a first part extending in a direction orthogonal to an axial direction of the winding portion and arranged at a position facing an end surface of the winding portion and a second part extending in the axial direction from the first part, the first and second parts being continuously formed without any joint, and a first relative magnetic permeability of the first part for a magnetic flux along an extension direction of the first part and a second relative magnetic permeability of the second part for a magnetic flux along an extension direction of the second part being different.

A segment of the present disclosure constitutes a part of a magnetic core provided in a reactor and made of a composite material containing a resin and a soft magnetic powder dispersed in the resin, and provided with a first part and a second part extending in a direction orthogonal to an extension direction of the first part, the first and second parts being continuously formed without any joint, and a first relative magnetic permeability of the first part for a magnetic flux along the extension direction of the first part and a second relative magnetic permeability of the second part for a magnetic flux along an extension direction of the second part being different.

A converter of the present disclosure is provided with the reactor of the present disclosure.

A power conversion device of the present disclosure is provided with the converter of the present disclosure.

### BRIEF DESCRIPTION OF THE DRAWINGS

FIG. 1 is a schematic top view of a reactor described in a first embodiment.

FIG. 2 is an X-Y cross-sectional picture of a first part provided in the reactor shown in FIG. 1.

FIG. 3 is a schematic top view of a reactor described in a second embodiment.

FIG. 4 is a schematic top view of a reactor described in a third embodiment.

FIG. 5 is a schematic top view of a reactor described in a fourth embodiment.

FIG. 6 is a configuration diagram schematically showing a power supply system of a hybrid vehicle.

FIG. 7 is a circuit diagram schematically showing an example of a power conversion device provided with a converter.

### DETAILED DESCRIPTION TO EXECUTE THE INVENTION

### Technical Problem

In recent years, reactors have tended to be used at high frequencies and with large currents. In a segment constituted by a powder compact, an iron loss may increase as higher frequencies are used. In a segment made of a composite material, an iron loss is small, but a leakage magnetic flux tends to increase. Accordingly, a reactor provided with segments, in which an increase of the iron loss and an increase of the leakage magnetic flux are suppressed, is required. Such a reactor has excellent magnetic properties particularly at high frequencies and at large currents.

One object of the present disclosure is to provide a reactor provided with a magnetic core capable of suppressing an increase of an iron loss and an increase of a leakage magnetic flux. Another object of the present disclosure is to provide a segment capable of suppressing an increase of an iron loss and an increase of a leakage magnetic flux. Still another object of the present disclosure is to provide a converter and a power conversion device provided with a reactor excellent in magnetic properties.

### Effect of Present Disclosure

In the reactor and the segment of the present disclosure, an increase of an iron loss and an increase of a leakage magnetic flux are suppressed. Further, the converter and the power conversion device of the present disclosure stably operate.

### Description of Embodiments of Present Disclosure

First, embodiments of the present disclosure are listed and described.

(1) A reactor according to an embodiment is provided with a coil including a winding portion and a magnetic core, the magnetic core including a plurality of segments including a first core piece, the first core piece being made of a composite material containing a resin and a soft magnetic powder dispersed in the resin, the first core piece including a first part extending in a direction orthogonal to an axial direction of the winding portion and arranged at a position facing an end surface of the winding portion and a second part extending in the axial direction from the first part, the first and second parts being continuously formed without any joint, and a first relative magnetic permeability of the first part for a magnetic flux along an extension direction of the first part and a second relative magnetic permeability of the second part for a magnetic flux along an extension direction of the second part being different.

An iron loss is less likely to increase in the first core piece made of the composite material than in a core piece constituted by a powder compact. This is because an increase of the iron loss is suppressed since the resin enters between respective particles of the soft magnetic powder and the respective particles hardly contact each other in the composite material. In the first core piece in the above configuration, the first and second parts are different in magnetic field transmissibility. Specifically, the extension direction of the first part and that of the second part are orthogonal to each other and either one of the first relative magnetic permeability along the extension direction of the first part and the second relative magnetic permeability along the extension direction of the second part is higher than the other. This place where the relative magnetic permeability is higher suppresses an increase of a leakage magnetic field in the first core piece. The reactor provided with such a first core piece exhibits excellent magnetic properties particularly at high frequencies and at large currents.

Since the resin is interposed between the respective particles of the soft magnetic powder inside the first core piece, the first core piece is assumed to include a magnetic gap. Therefore, the magnetic core including this first core piece is hardly magnetically saturated. The reactor provided with the first core piece to be hardly magnetically saturated stably operates particularly at high frequencies and at large currents.

(2) In the reactor of (1) described above, the first relative magnetic permeability may be higher than the second relative magnetic permeability.

The first part having the first relative magnetic permeability is arranged outside the winding portion of the coil. A leakage magnetic field in the first part may adversely affect other electronic devices arranged near the reactor. If the first relative magnetic permeability is high, the leakage magnetic field in the first part is reduced and an adverse influence on the other electronic devices is reduced.

(3) In the reactor of (1) or (2) described above, the first core piece has an E shape including a base portion and three leg portions extending from the base portion, the base portion is the first part, and each of the three leg portions is the second part.

In the above configuration, the number of the segments of the magnetic core can be small. A core piece to be combined with the E-shaped core piece is an E-shaped core piece, a T-shaped core piece or an I-shaped core piece. In this case, the number of the segments of the magnetic core is two.

(4) In the reactor of any one of (1) to (3) described above, the magnetic core includes the first core piece and a second core piece having the same configuration as the first core piece.

The “same configuration” means being substantially the same in shape, dimensions, material and composition. In the configuration of (4) described above, the first and second core pieces are fabricated, using the same composite material and the same mold. Therefore, the productivity of the magnetic core is improved and the productivity of the reactor provided with the magnetic core is also improved.

The first and second core pieces having the same configuration are, for example, E-shaped core pieces. Besides, the first and second core pieces may be, for example, F-shaped core pieces.

(5) A segment according to an embodiment constitutes a part of a magnetic core provided in a reactor and made of a composite material containing a resin and a soft magnetic powder dispersed in the resin, and provided with a first part and a second part extending in a direction orthogonal to an extension direction of the first part, the first and second parts being continuously formed without any joint, and a first relative magnetic permeability of the first part for a magnetic flux along the extension direction of the first part and a second relative magnetic permeability of the second part for a magnetic flux along an extension direction of the second part being different.

An iron loss is less likely to increase in the segment made of the composite material than in a segment constituted by a powder compact. This is because the resin easily enters between respective particles of the soft magnetic powder. In the segment of the above configuration, either one of the first and second parts has a higher relative magnetic permeability than the other. This place where the relative magnetic permeability is higher suppresses an increase of a leakage magnetic field in the segment.

(6) A converter according to an embodiment is provided with the reactor of any one of (1) to (5) described above.

The above converter is provided with the reactor having excellent magnetic properties and to be hardly magnetically saturated. Therefore, the above converter stably exhibits excellent performance.

(7) A power conversion device according to an embodiment is provided with the converter of (6) described above.

The above power conversion device is provided with the converter stably exhibiting excellent performance. Therefore, the above power conversion device stably exhibits excellent performance.

### Details of Embodiments of Present Disclosure

Hereinafter, embodiments of the present disclosure are described on the basis of the drawings. The same reference signs in figures denote the same components. Note that the present invention is not limited to configurations shown in the embodiments, but is represented by claims and intended to include all changes in the scope of claims and in the meaning and scope of equivalents.

### First Embodiment

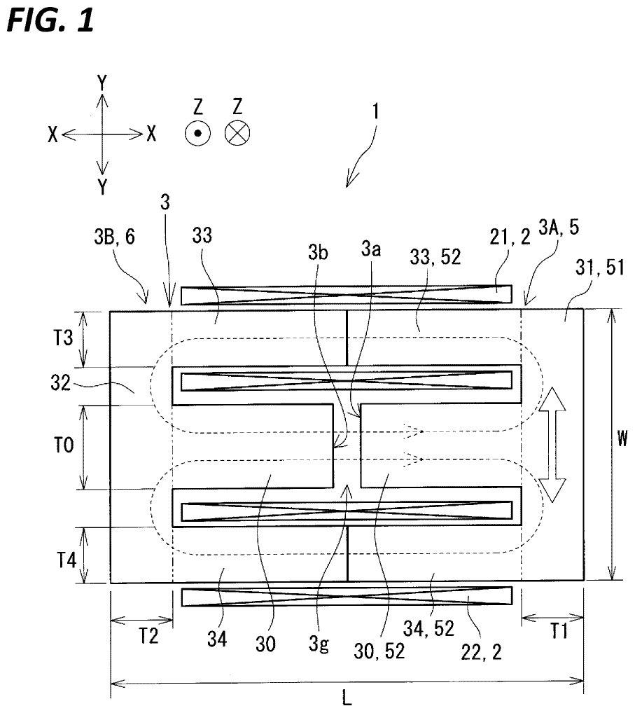

A reactor 1 of this example shown in FIG. 1 is configured by combining a coil 2 and a magnetic core 3. One of features of this reactor 1 is that the magnetic core 3 includes a first core piece 5 constituted by a compact of a composite material and a relative magnetic permeability partially changes in the first core piece 5. Each component of the reactor 1 is described in detail below.

### Coil

The coil 2 includes at least one winding portion 21, 22. The coil 2 of this example includes the winding portions 21 and 22. The winding portion 21, 22 is configured by helically winding a winding wire. A known winding wire can be used as the winding wire. The winding wire of this embodiment is a coated rectangular wire composed of a conductor wire including an insulation coating. The conductor wire is, for example, constituted by a rectangular wire made of copper. The insulation coating is, for example, made of enamel. The winding portion 21, 22 of this example is an edgewise coil formed by winding the coated rectangular wire edgewise.

The winding portion 21, 22 has a rectangular tube shape. That is, an end surface shape of the winding portion 21, 22 of this example is a rectangular frame shape. Corner parts of the winding portion 21, 22 of this example are rounded. Since the winding portion 21, 22 has the rectangular tube shape, a contact area of the winding portion 21 with an insulation target tends to be large as compared to the case where a winding portion is in the form of a hollow cylinder having the same cross-sectional area. Thus, the reactor 1 easily dissipates heat to the installation target via the winding portion 21, 22. Further, an installed state of the winding portion 21, 22 with respect to the installation target is easily stabilized.

Unillustrated end parts of the winding portion 21, 22 are pulled out to an outer peripheral side of the winding portion 21, 22. The insulation coating is stripped to expose the conductor wire in the end parts of the winding portion 21, 22. An unillustrated terminal member is connected to the exposed conductor wire. The winding portions 21, 22 of this example are respectively connected to independent power supplies. Unlike this example, the winding portions 21, 22 may be connected to one power supply.

### Magnetic Core

The magnetic core 3 includes a middle core portion 31, a first end core portion 31, a second end core portion 32, a first side core portion 33 and a second side core portion 34. The magnetic core of this example has an “8” shape connecting two annular shapes. In FIG. 1, boundaries between the respective core portions are shown by two-dot chain lines. The middle core portion 30 is sandwiched between the first and second side core portions 33, 34. The first end core portion 31 is facing first end surfaces, i.e. right end surfaces in FIG. 1, of the winding portions 21, 22. The second end core portion 32 is facing second end surfaces, i.e. left end surfaces in FIG. 1, of the winding portions 21, 22. The first side core portion 33 is arranged inside the winding portion 21. The second side core portion 34 is arranged inside the winding portion 22.

In this magnetic core 3, an annular closed magnetic path shown by a thick broken line is formed in the middle core portion 30, the first end core portion 31, the first side core portion 33 and the second end core portion 32. Further, an annular closed magnetic path shown by a thick broken line is formed in the middle core portion 30, the first end core portion 31, the second side core portion 34 and the second end core portion 32.

Here, directions in the reactor 1 are defined on the basis of the magnetic core 3. First, a direction along an axial direction of the middle core portion 30 is an X direction. A parallel direction of the middle core portion 31, the side core portions 33 and the second side core portion 34 orthogonal to the X direction is a Y direction. A direction orthogonal to the both X and Y directions is a Z direction. In this specification, an axial direction of a member includes a direction from one end part toward the other end part of the member along an axis of the member and a direction opposite to the former direction.

### Middle Core Portion

An extension direction, i.e. an axial direction, of the middle core portion 30 is a direction along an axial direction of the winding portion 21 and that of the winding portion 22. If there is one winding portion 21 as shown in a third embodiment to be described later, the winding portion 21 is arranged on the outer periphery of the middle core portion 30.

The shape of the middle core portion 30 is not particularly limited if sufficient magnetic paths are formed inside the middle core portion 30. The middle core portion 30 of this example has a substantially rectangular parallelepiped shape. Two magnetic paths are formed in the middle core portion 30. Accordingly, a magnetic path cross-sectional area of the middle core portion 30 is larger than that of the first side core portion 33 and that of the second side core portion 34.

### First End Core Portion, Second End Core Portion

The first and second end core portions 31, 32 extend in the Y direction orthogonal to the axis of the middle core portion 30 and are larger than a width in the Y direction of the middle core portion 30. That is, the first end core portion 31 protrudes outward in the Y direction from the middle core portion 30. The second end core portion 32 protrudes outward in the Y direction from the middle core portion 30.

The shapes of the first and second end core portions 31, 32 are not particularly limited if sufficient magnetic paths are formed inside the first and second end core portions 31, 32. The first and second end core portions 31, 32 of this example have a substantially rectangular parallelepiped shape. Out of four corner parts of each of the first and second end core portions 31, 32 when viewed from the Z direction, two corner parts at positions distant from the both side core portions 33, 34 may be rounded. If the above two corner parts are rounded, a weight of the end core portion 31, 32 is reduced. The above two corner parts are parts where a magnetic flux hardly passes. Therefore, even if the above two corner parts are rounded, the magnetic properties of the reactor 1 are hardly reduced.

### First Side Core Portion, Second Side Core Portion

The first side core portion 33 connects one end part in an extension direction of the first end core portion 31 and one end part in an extension direction of the second end core portion 32. An axial direction of the first side core portion 33 is parallel to that of the middle core portion 30. The first side core portion 33 is arranged inside the winding portion 21.

The second side core portion 34 connects the other end part in the extension direction of the second end core portion 31 and the other end part in the extension direction of the second end core portion 32. An axial direction of the second side core portion 34 is parallel to that of the middle core portion 30. The second side core portion 34 is arranged inside the winding portion 22. In this example, the axis of the middle core portion 30, that of the first side core portion 33 and that of the second side core portion 34 are arranged on an X-Y plane.

### Sizes

If the reactor 1 shown in FIG. 1 is for vehicle, a length L in the X direction of the magnetic core 3 is, for example, 30 mm or more and 150 mm or less, a width W in the Y direction of the magnetic core 3 is, for example, 30 mm or more and 150 mm or less, and a height in the Z direction is, for example, 15 mm or more and 75 mm or less.

A length TO in the Y direction of the middle core portion 30 is, for example, 10 mm or more and 50 mm or less. A length T1 in the X direction of the first end core portion 31 and a length T2 in the X direction of the second end core portion 32 are, for example, 5 mm or more and 40 mm or less. Further, a length T3 in the Y direction of the first side core portion 33 and a length T4 in the Y direction of the second side core portion 34 are, for example, 5 mm or more and 40 mm or more. These lengths relate to a size of the magnetic path cross-sectional area of the magnetic core 3.

### Divided Form

The magnetic core 3 is formed by combining a plurality of segments 3A, 3B. Two segments 3A, 3B are provided in this example, but three or more segments may be provided. The segment 3A is a first core piece 5 constituted by a compact of a composite material to be described later. The first core piece 5 is one compact and has no joint. The segment 3B is a second core piece 6 constituted by a compact of a composite material. The second core piece 6 has the same configuration as the first core piece 5.

The first core piece 5 of this example is provided with a base portion and three leg portions extending from the base portion. The first core piece 5 has a substantially E shape when viewed from the Z direction. As described later, the base portion and the leg portions have different relative magnetic permeabilities. Accordingly, the base portion is called a first part 51 and the leg portions are called second parts 52. The first part 51 corresponds to the first end core portion 31. The second part 52 located in a center in the Y direction corresponds to a part of the middle core portion 30. The second part 52 located on an upper side in the Y direction in FIG. 1 corresponds to the first side core portion 33. The second part 52 located on a lower side in the Y direction in FIG. 1 corresponds to the second side core portion 34. The second part 52 corresponding to the middle core portion 30 has a first end surface 3a parallel to a Y-Z plane.

The second core piece 6 of this example constitutes a part of the magnetic core 3 except the first core piece 5. Specifically, the second core piece 6 has the same configuration as the first core piece 5. The second core piece 6 is constituted by the second end core portion 32, a part of the middle core portion 30, a part of the first side core portion 33 and a part of the second side core portion 34. The second core piece 6 has a substantially E shape when viewed from the Z direction. A part corresponding to the middle core portion 30 has a second end surface 3b parallel to the Y-Z plane.

A gap 3g is formed between the first and second end surfaces 3a, 3b. This gap 3g functions as a magnetic gap.

### Magnetic Properties, Materials, Etc.

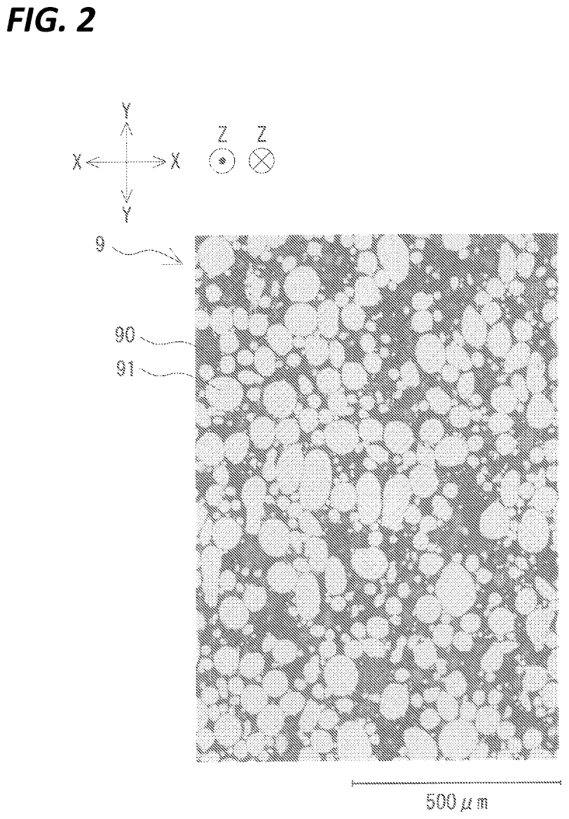

The first core piece 5 is the compact of the composite material. FIG. 2 is an enlarged picture of a cross-section of the first part 51 of the first core piece 5 cut by an X-Y plane. As shown in FIG. 2, a composite material 9 contains a solidified resin 90 and a soft magnetic powder 91 dispersed in the resin 90. In FIG. 2, a grey part is the resin 90 and a white part is each particle of the soft magnetic powder 91. The soft magnetic powder 91 is an aggregate of soft magnetic particles made of iron group metal such as iron or iron alloy such as Fe (iron)-Si (silicon) alloy or Fe—Ni (nickel) alloy. An insulation coating made of phosphate may be formed on the surface of the soft magnetic particle.

The resin 90 may be a thermosetting resin or a thermoplastic resin. The thermosetting resin is, for example, an unsaturated polyester resin, an epoxy resin, a urethane resin or a silicone resin. The thermoplastic resin is, for example, a polyphenylene sulfide (PPS) resin, a polytetrafluoroethylene (PTFE) resin, a liquid crystal polymer (LCP), a polyamide (PA) resin such as nylon 6 or nylon 66, a polybutylene terephthalate (PBT) resin or an acrylonitrile-butadiene-styrene (ABS) resin. Besides, the resin 90 may be, for example, a BMC (Bulk Molding Compound) in which calcium carbonate and glass fibers are mixed in an unsaturated polyester, a millable-type silicone rubber or a millable-type urethane rubber.

The composite material 9 may contain a non-metal powder besides the resin 90 and the soft magnetic powder 91. The non-metal powder improves the heat dissipation of the compact of the composite material 9. The non-metal powder is, for example, a ceramic filler such as alumina or silica. The ceramic filler is also a nonmagnetic material. A content of the non-metal powder in the composite material 9 is, for example, 0.2% by mass or more and 20% by mass or less, further 0.3% by mass or more and 15% by mass or less, or 0.5% by mass or more and 10% by mass or less.

A content of the soft magnetic powder 91 in the composite material 9 is, for example, 30% by volume or more and 80% by volume or less. From the perspective of improving a saturated magnetic flux density and heat dissipation, the content of the soft magnetic powder 91 may be 50% by volume or more, 60% by volume or more or 70% by volume or more. From the perspective of improving fluidity in a manufacturing process, the content of the soft magnetic powder 91 may be 75% by volume or less. A relative magnetic permeability of the compact of the composite material 9 tends to decrease as a filling rate of the soft magnetic powder 91 decreases. The relative magnetic permeability of the compact of the composite material 9 is, for example, 5 or more and 50 or less. Further, the relative magnetic permeability of the compact of the composite material 9 may be 10 or more and 45 or less, 15 or more and 40 or less, or 20 or more and 35 or less.

As shown in FIG. 2, a plurality of particles of the soft magnetic powder 91 contained in the first part 51 are oriented in the Y direction. “A state where the particles are oriented in the Y direction” mentioned here means at least one of a state where major diameters of the particles are substantially along the Y direction and a state where a plurality of particles are connected in a chain to reduce magnetic resistance. The first part 51 in which the plurality of particles of the soft magnetic powder 91 are oriented in the Y direction easily transmits a magnetic flux along the Y direction. As shown in FIG. 1, the magnetic flux flows in the Y direction in the first part 51 as indicated by broken-line arrows. Therefore, a first relative magnetic permeability of the first part 51 for a magnetic flux along an extension direction of the first part 51 is higher than that of a composite material in which particles are not oriented in any direction.

Here, a cross-section of the second part 52 of this example cut by an X-Y plane also looks substantially similar to the cross-section shown in FIG. 2. That is, a plurality of particles of the soft magnetic powder contained in the second part 52 are also oriented in the Y direction. As shown by the broken-line arrow in FIG. 1, a magnetic flux flows in the X direction in the second part 52. The magnetic flux hardly flows in the X direction orthogonal to the orientation direction of the particles. Therefore, a second relative magnetic permeability of the second part 52 along an extension direction of the second part 52 is nearly equal to or lower than that of a composite material in which particles are not oriented in any direction.

As described above, the first relative magnetic permeability is higher than the second relative magnetic permeability although the first and second parts 51, 52 are continuously formed without any joint. A manufacturing method of such a first core piece 5 is as follows.

The first core piece 5 of the composite material 9 is manufactured by resin molding of filling a mixture of the non-solidified resin 90 and the soft magnetic powder 91 into a mold and solidifying the resin 90. During this resin molding, a magnetic field is applied in a direction indicated by a white arrow of FIG. 1, i.e. in the Y direction. By applying the magnetic field in the Y direction, the plurality of particles of the soft magnetic powder 91 are oriented in the Y direction. As the magnetic field during the resin molding becomes larger, the number of the particles oriented in the Y direction tends to increase. A magnitude of the magnetic field may be, for example, 15 kOe (about 1.19×10⁶ A/m) or more, 18 kOe (about 1.43×10⁶ A/m) or more, or 20 kOe (about 15.9×10⁶ A/m) or more.

Unlike this example, a magnetic field may be applied in the X direction of FIG. 1 during the resin molding. In that case, a plurality of particles of the soft magnetic powder 91 are oriented in the X direction. As a result, the second relative magnetic permeability of the second part 52 for the magnetic field along the extension direction of the second part 52 becomes higher than the first relative magnetic permeability of the first part 51 for the magnetic field along the extension direction of the first part 51.

The second core piece 6 of this example has the same configuration as the first core piece 5 as already described. That is, all of the shape, dimensions, material and composition of the second core piece 6 are substantially the same as those of the first core piece 5. Therefore, a part of the second core piece 6 corresponding to the second end core portion 32 has the same configuration of the first part 51 of the first core piece 5, and parts corresponding to the other core portions 30, 33, 34 have the same configuration as the second parts 52 of the first core piece 5.

### Miscellaneous

The reactor 1 of this example may be provided with a resin molded portion for integrating the coil 2 and the magnetic core 3. The molded resin portion may cover an entire assembly of the coil 2 and the magnetic core 3 or may cover only a part of the assembly. A resin constituting the molded resin portion is, for example, a PBT resin. A ceramic filler such as alumina may be contained in these resins.

### Summary

The reactor 1 of this example exhibits excellent magnetic properties at high frequencies and at large currents.

The reactor 1 of this example is provided with the magnetic core 3 including the first core piece 5. The first core piece 5 is made of the composite material, and an iron loss in the composite material is smaller than that in a powder compact. Further, the first part 51 of the first core piece 5 more easily transmits a magnetic flux than the second parts 52. Therefore, the magnetic flux hardly leaks to the outside of the reactor 1 from the first part 51. Since the first core piece 5 made of the composite material is assumed to include the magnetic gap, the first core piece 5 is hardly magnetically saturated. The reactor 1 of this example is further provided with the second core piece 6 having the same configuration as the first core piece 5. Therefore, the reactor 1 of this example exhibits excellent magnetic properties at high frequencies and at large currents.

The reactor 1 of this example is excellent in productivity.

The magnetic core 3 provided in the reactor 1 of this example is composed of the first and second core pieces 5, 6. Accordingly, the magnetic core 3 is completed only by combining the first and second core pieces 5, 6. Further, the first and second core pieces 5, 6 have the same configuration. That is, the first and second core pieces 5, 6 are manufactured by exactly the same manufacturing method. Therefore, one mold may be prepared and one kind of the composite material may be used to manufacture the magnetic core 3.

### First Modification

First and second modifications are described below. Points of difference from the first embodiment are mainly described in the first and second modifications. The configuration other than the points of difference is common to the first embodiment. A second core piece 6 of the first modification may be a powder compact. The powder compact is fabricated by compression-forming a raw powder containing a soft magnetic powder. This soft magnetic powder is not particularly limited. The raw powder may contain a lubricant. A content of the soft magnetic powder is more easily increased in the powder compact than in the compact of the composite material 9. For example, the content of the soft magnetic powder in the powder compact is 80% by volume or more, further 85% by volume or more. The powder compact tends to have a high saturation magnetic flux density and a high relative magnetic permeability. The relative magnetic permeability of the powder compact is, for example, 50 or more and 500 or less. The relative magnetic permeability of the powder compact may be 80 or more, 100 or more, 150 or more, or 180 or more.

Since the magnetic core 3 is provided with the first core piece 5 constituted by the compact of the composite material and the second core piece 6 constituted by the powder compact, a leakage magnetic flux is easily reduced and an inductance is easily adjusted.

### Second Modification

The second core piece 6 may be a compact of a composite material fabricated without applying a magnetic field during resin molding. In this second modification, a mold for fabricating a powder compact is not necessary unlike the first modification.

### Second Embodiment

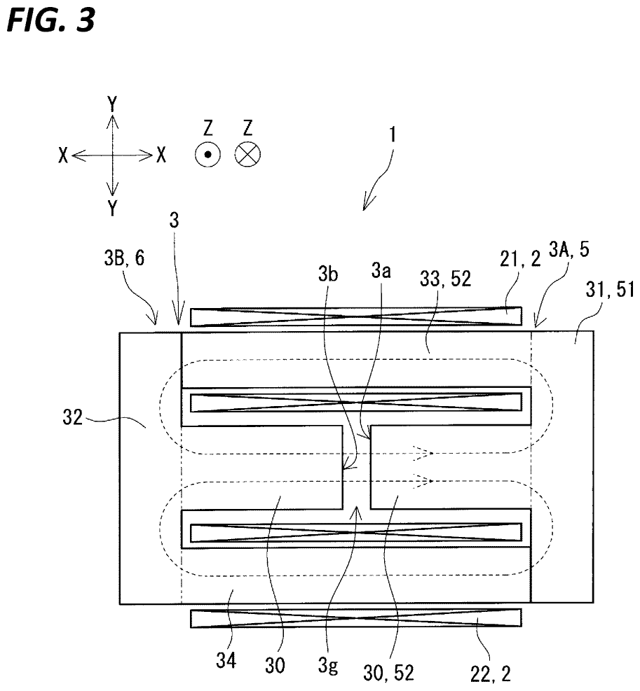

A reactor 1 according to a second embodiment is described with reference to FIG. 3. The reactor 1 of the second embodiment differs from the reactor 1 of the first embodiment in a divided state of a magnetic core 3. The configuration other than the divided state of the magnetic core 3 in the reactor 1 of this example is the same as that of the reactor 1 of the first embodiment.

A first core piece 5 of this example is composed of a first end core portion 31, a part of a middle core portion 30 and a first side core portion 33. The first core piece 5 has a substantially F shape when viewed from the Z direction. The first core piece 5 is a compact of a composite material in which a soft magnetic powder is oriented in the Y direction or the X direction.

A second core piece 6 is composed of a second end core portion 32, a part of the middle core portion 30 and a second side core portion 34. The second core piece 6 has a substantially F shape when viewed from the Z direction. The shape of the second core piece 6 when viewed from the Z direction may be the same as or different from that of the first core piece 5. The second core piece 6 is a compact of a composite material in which a soft magnetic powder is oriented in the Y direction or the X direction. Unlike this example, the second core piece 6 may be a powder compact.

### Third Embodiment

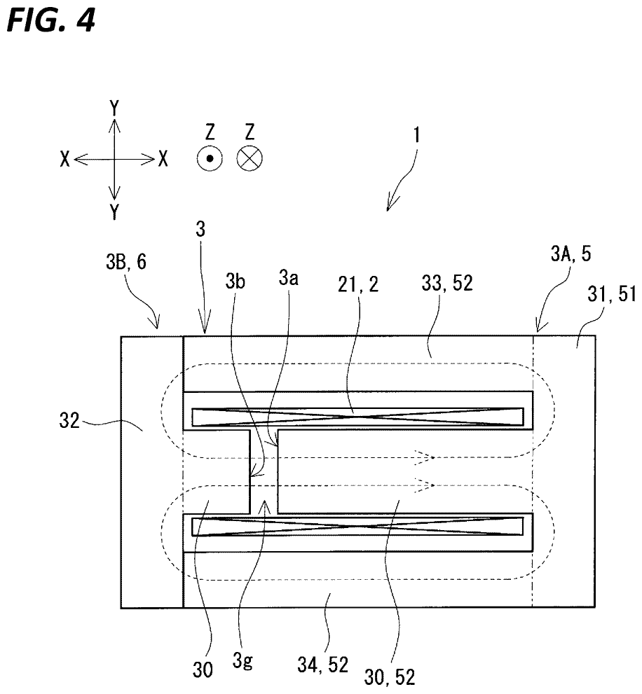

A reactor 1 according to a third embodiment is described with reference to FIG. 4. The description of this example is centered on points of difference between the reactor 1 of the third embodiment and the reactor 1 of the first embodiment.

A first core piece 5 of this example is composed of a first end core portion 31, a part of a middle core portion 30, a first side core portion 33 and a second side core portion 34. The first core piece 5 has a substantially E shape when viewed from the Z direction. The first core piece 5 is a compact of a composite material in which a soft magnetic powder is oriented in the Y direction or the X direction.

A second core piece 6 is composed of a second end core portion 32 and a part of the middle core portion 30. The second core piece 6 has a substantially T shape when viewed from the Z direction. The second core piece 6 is a compact of a composite material in which a soft magnetic powder is oriented in the Y direction or the X direction.

A coil 2 of this example includes one winding portion 21. The winding portion 21 is arranged on the outer periphery of the middle core portion 30. In this example in which the winding portion 21 is arranged on the outer periphery of the middle core portion 30, magnetic properties of the reactor 1 tend to be higher if a second relative magnetic permeability of second parts 52 is higher than a first relative magnetic permeability of a first part 51.

Unlike this example, the second core piece 6 may be a powder compact. Further, the coil 2 may include two winding portions 21. In that case, one winding portion 21 is arranged on the outer periphery of the first side core portion 33 and the other winding portion 21 is arranged on the outer periphery of the second side core portion 34.

### Fourth Embodiment

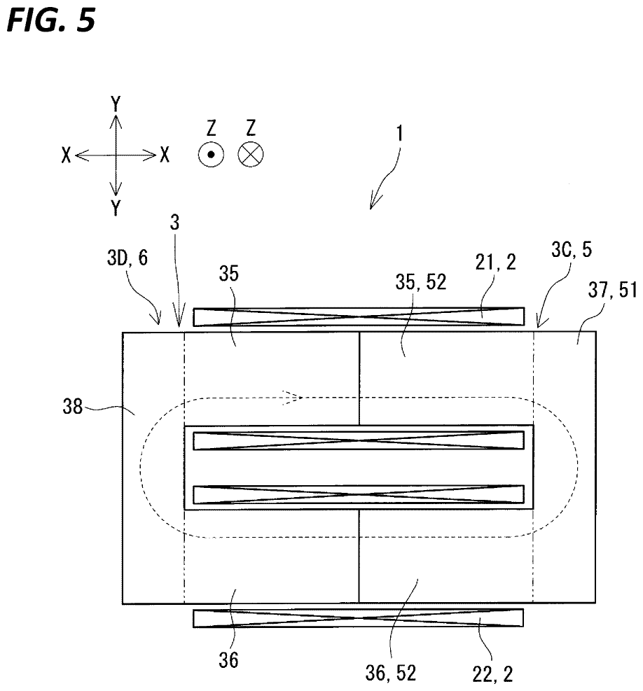

A reactor 1 according to a fourth embodiment is described with reference to FIG. 5. A magnetic core 3 of this example has a rectangular annular shape. The magnetic core 3 includes two inner core portions 35, 36 and two outer core portions 37, 38. The inner core portions 35, 36 are arranged inside winding portions 21, 22. The outer core portions 37, 38 are arranged at positions facing end surfaces of the winding portions 21, 22.

The magnetic core 3 is composed of two segments 3C, 3D. The segment 3C is composed of a part of the inner core portion 35, a part of the inner core portion 36 and the outer core portion 37. The segment 3D is composed of a part of the inner core portion 35, a part of the inner core portion 36 and the outer core portion 38. The segment 3C, 3D has a substantially U shape when viewed from the Z direction. The segment 3C, 3D is a compact of a composite material in which a soft magnetic powder is oriented in the Y direction or the X direction. Therefore, the segment 3C is a first core piece 5 including one first part 51 and two second parts 52, and the segment 3D is a second core piece 6 including one first part 51 and two second parts 52. The first and second core pieces 5, 6 have the same configuration. Unlike this example, the second core piece 6 may be a powder compact.

As a modification, the first and second core pieces 5, 6 may have a substantially L shape when viewed from the Z direction. That is, the first core piece 5 may be composed of the inner core portion 35 and the outer core portion 37, and the second core piece 6 may be composed of the inner core portion 36 and the outer core portion 38.

### Fifth Embodiment

### Converter, Power Conversion Device

The reactors 1 of the above embodiments can be utilized for applications satisfying the following energizing conditions. The energizing conditions include, for example, a maximum direct current of about 100 A or more and 1000 A or less, an average voltage of about 100 V or more and 1000 V or less and a use frequency of about 5 kHz or more and 100 kHz or less. The reactors 1 of the embodiments can be typically used as a constituent component of a converter to be installed in a vehicle such as an electric vehicle or a hybrid vehicle or as a constituent component of a power conversion device provided with this converter.

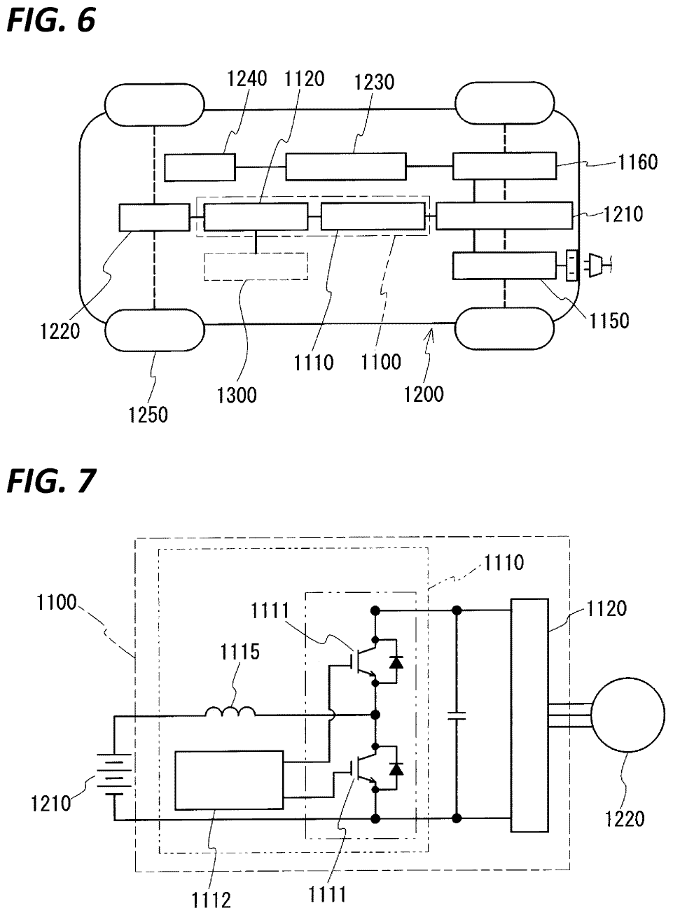

A vehicle 1200 such as a hybrid vehicle or an electric vehicle is, as shown in FIG. 6, provided with a main battery 1210, a power conversion device 1100 connected to the main body 1210 and a motor 1220 used for travel by being driven by power supplied from the main body 1210. The motor 1220 is, typically, a three-phase alternating current motor, drives wheels 1250 during travel and functions as a generator during regeneration. In the case of a hybrid vehicle, the vehicle 1200 includes an engine 1300 in addition to the motor 1220. FIG. 6 shows an inlet as a charging point of the vehicle 1200, but the vehicle 1200 may include a plug.

The power conversion device 1100 includes a converter 1110 to be connected to the main battery 1210 and an inverter 1120 connected to the converter 1110 for the mutual conversion of a direct current and an alternating current. The converter 1110 shown in this example steps up an input voltage of the main battery 1210 of about 200 V or more and 300 V or less to about 400 V or more and 700 V or less and supplies the stepped-up voltage to the inverter 1120 during the travel of the vehicle 1200. The converter 1110 steps down an input voltage output from the motor 1220 via the inverter 1120 to a direct-current voltage suitable for the main battery 1210 and charges the main battery 1210 with the direct-current voltage during regeneration. The input voltage is a direct-current voltage. The inverter 1120 converts the direct current stepped up by the converter 1110 into a predetermined alternating current and supplies the converted current to the motor 1220 during the travel of the vehicle 1200 and converts an alternating current output from the motor 1220 into a direct current and outputs the direct current to the converter 1110 during regeneration.

The converter 1110 includes a plurality of switching elements 1111, a drive circuit 1112 for controlling the operation of the switching elements 1111 and a reactor 1115 as shown in FIG. 7 and converts an input voltage by being repeatedly turned on and off. The conversion of the input voltage means voltage step-up and-down here. A power device such as a field effect transistor or an insulated gate bipolar transistor is used as the switching element 1111. The reactor 1115 has a function of smoothing a change of a current when the current is increased or decreased by a switching operation, using a property of a coil to hinder a change of a current flowing into a circuit. Any one of the reactors 1 according to the embodiments is provided as the reactor 1115.

Besides the converter 1110, the vehicle 1200 is provided with a power supply device converter 1150 connected to the main battery 1210 and an auxiliary power supply converter 1160 connected to a sub-battery 1230 and the main battery 1210 serving as power sources of auxiliary devices 1240 and configured to convert a high voltage of the main battery 1210 into a low voltage. The converter 1110 typically performs DC-DC conversion, but the power supply device converter 1150 and the auxiliary power supply converter 1160 perform AC-DC conversion. The power supply device converter 1150 may perform DC-DC conversion. Reactors configured similarly to the reactors 1 according to the embodiments and appropriately changed in size, shape and the like can be used as reactors of the power supply device converter 1150 and the auxiliary power supply converter 1160. Further, the reactors 1 according to the embodiments and the like can also be used in a converter for converting input power and only stepping up a voltage or only stepping down a voltage.

The converter 1110 and the power conversion device 1100 provided with the reactor 1 of the embodiment having stable magnetic properties stably exhibit excellent magnetic properties.

### Test Example 1

In Test Example 1, an effect of influencing a first core piece 5 having partially different relative magnetic permeabilities on the performance of a reactor 1 was examined. In this test, a test reactor including the first core piece 5 and a test reactor including a core piece made of a conventional composite material were fabricated and inductances of the both test reactors were compared. The both test reactors have the same external appearance as the reactor 1 shown in FIG. 4. Therefore, the following description is given with reference to FIG. 4.

### Sample No. 1

A segment 3A in a test reactor of Sample No. 1 is a compact of a composite material fabricated without applying a magnetic field during resin molding. A segment 3B in the test reactor of Sample No. 1 is a powder compact.

### Sample No. 2

A segment 3A in a test reactor of Sample No. 2 is a first core piece 5 fabricated by resin molding while applying a magnetic field in the X direction. A segment 3B in the test reactor of Sample No. 2 is a powder compact having the same configuration as Sample No. 1.

An inductance of Sample No. 1 and an inductance of Sample No. 2 were measured under the same measurement conditions. As a result, the inductance of Sample No. 2 was higher than that of Sample No. 1 by 6%. Therefore, it was found that the first core piece 5 containing a soft magnetic powder oriented in the X direction contributed to improving magnetic properties of the reactor 1.

### Test Example 2

A first test piece and a second test piece having a cubic shape are respectively cut out from a first part 51 and a second part 52 of the first core piece 5 of Test Example 1, and a relative magnetic permeability of each test piece was measured by a B-H evaluation facility. Each test piece had a size of 7 mm×7 mm×7 mm.

The relative magnetic permeability in the Y direction of the first part 51 was measured by applying a magnetic field of the B-H evaluation facility to the first test piece in the Y direction. Specifically, the first test piece was so set in the B-H evaluation facility that the Y direction of the first test piece extended along the magnetic field of the B-H evaluation facility, and a relative magnetic permeability of the first test piece was measured. Further, by applying the magnetic field of the B-H evaluation facility in the X direction of the second test piece, a relative magnetic permeability in the X direction of the second part 52 was measured. Specifically, the second test piece was so set in the B-H evaluation facility that the X direction of the second test piece extended along the magnetic field of the B-H evaluation facility and a relative magnetic permeability of the second test piece was measured. As a result, it was found that the relative magnetic permeability in the X direction of the second part 52 was higher than the relative magnetic permeability in the Y direction of the first part 51.

### LIST OF REFERENCE NUMERALS

1 reactor
2 coil
21, 22 winding portion
3 magnetic core
3a first end surface, 3b second end surface, 3g gap
3A, 3B, 3C, 3D segment
30 middle core portion, 31 first end core portion, 32 second end core portion,
33 first side core portion, 34 second side core portion,
35, 36 inner core portion, 37, 38 outer core portion
5 first core piece
51 first part, 52 second part
6 second core piece
9 composite material
90 resin, 91 soft magnetic powder
1100 power conversion device
1110 converter, 1111 switching element, 1112 drive circuit
1115 reactor, 1120 inverter
1150 power supply device converter, 1160 auxiliary power supply converter
1200 vehicle
1210 main battery, 1220 motor, 1230 sub-battery
1240 auxiliary devices, 1250 wheel
1300 engine
L, T0, T1, T2, T3, T4 length
W width

1. A reactor, comprising:
a coil including a winding portion; and
a magnetic core;
the magnetic core including a plurality of segments including a first core piece, the first core piece being made of a composite material containing a resin and a soft magnetic powder dispersed in the resin, the first core piece including a first part extending in a direction orthogonal to an axial direction of the winding portion and arranged at a position facing an end surface of the winding portion and a second part extending in the axial direction from the first part,
the first and second parts being continuously formed without any joint, and
a first relative magnetic permeability of the first part for a magnetic flux along an extension direction of the first part and a second relative magnetic permeability of the second part for a magnetic flux along an extension direction of the second part being different.

2. The reactor of claim 1, wherein the first relative magnetic permeability is higher than the second relative magnetic permeability.

3. The reactor of claim 1, wherein:
the first core piece has an E shape including a base portion and three leg portions extending from the base portion,
the base portion is the first part, and
each of the three leg portions is the second part.

4. The reactor of any one of claim 1, wherein the magnetic core includes the first core piece and a second core piece having the same configuration as the first core piece.

5. A segment constituting a part of a magnetic core provided in a reactor and made of a composite material containing a resin and a soft magnetic powder dispersed in the resin, comprising:
a first part; and
a second part extending in a direction orthogonal to an extension direction of the first part,
the first and second parts being continuously formed without any joint, and
a first relative magnetic permeability of the first part for a magnetic flux along the extension direction of the first part and a second relative magnetic permeability of the second part for a magnetic flux along an extension direction of the second part being different.

6. A converter, comprising the reactor of claim 1.

7. A power conversion device, comprising the converter of claim 6.
